(19) United States
(12) Patent Application Publication
(10) Pub. No.: US 2022/0339832 A1
(43) Pub. Date: Oct. 27, 2022

(54) NO-MOLD-RUNNER MULTI-NOZZLE DEVICE

(71) Applicant: Tederic Machinery Co.,Ltd., Hangzhou (CN)

(72) Inventors: Jianguo Zheng, Hangzhou (CN); Hongwei Zhou, Hangzhou (CN); Wu Lin, Hangzhou (CN); Jianqin Zeng, Hangzhou (CN); Guolin Liu, Hangzhou (CN); Shixin Deng, Hangzhou (CN); Binqi Rao, Hangzhou (CN); Binbin Li, Hangzhou (CN); Chenwen Fang, Hangzhou (CN); Lu Zhang, Hangzhou (CN)

(21) Appl. No.: 17/703,582

(22) Filed: Mar. 24, 2022

(30) Foreign Application Priority Data
Mar. 30, 2021 (CN) 202110341102.XA
Mar. 30, 2021 (CN) 202110341103.4A

(51) Int. Cl. B29C 45/22; B29C 45/23; B29C 45/17; B29C 45/16

(52) U.S. Cl. CPC B29C 45/22; B29C 45/231; B29C 45/1704; B29C 45/1775; B29C 45/1603; B29C 2945/76187; B29C 2045/1698; B29C 2945/7604; B29C 2945/7629; B29C 2945/76859; B29C 2945/76688

(57) ABSTRACT

For processing cost reduction and improvement of efficiency, a no-mold-runner multi-nozzle device, comprising: an injection machine, a multi-nozzle component, a front template, and a no-mold-runner. The multi-nozzle component includes a plurality of nozzles, which is connected to the injection machine. The injection machine is used to inject a mixture of molding material and supercritical fluid into multiple nozzles. The front template is provided with a plurality of first passage holes. The no-mold-runner is provided with a mold cavity and a plurality of second passage holes communicating with the mold cavity. The nozzle correspondingly passes through a plurality of first passage holes and second passage holes and is installed in cooperation. By controlling the opening or closing of the nozzle, the mixed material of the molding material and the supercritical fluid enters the mold cavity or stops entering the mold cavity.

### CROSS-REFERENCE TO RELATED APPLICATIONS

This application claims priority to Chinese State Intellectual Patent Application Number 202110341103.4 entitled “A NO-MOLD-RUNNER MULTI-NOZZLE DEVICE” and filed on Mar. 30, 2021, for TEDERIC MACHINERY CO., LTD, and Number 202110341102.X entitled “AN INJECTION DEVICE OF INJECTION MOLDING MACHINE, INJECTION MOLDING MACHINE AND A CONTROL METHOD THEREOF” and filed on Mar. 30, 2021, for TEDERIC MACHINERY CO., LTD, the entire contents of which are incorporated by reference for all purposes.

### Field

The invention relates to the field of injection molding, in particular to a no-mold-runner multi-nozzle device and a control method.

### BACKGROUND

### Description of the Related Art

Micro-foam injection molding may save material.

### BRIEF SUMMARY

A no-mold-runner multi-nozzle device is disclosed. The no-mold-runner multi-nozzle device includes an injection machine, a multi-nozzle component connected to the injection machine, a front template comprising a plurality of first passage holes, a no-mold-runner comprising a mold cavity and a plurality of second passage holes communicating with the mold cavity, and the number of the second passage holes is not greater than the number of the first passage holes, and a plurality of nozzles that pass through the corresponding plurality of first passage holes and communicating with the second passage holes, wherein the injection machine injects and fills material mixed with molding material and the supercritical fluid into the mold through a plurality of nozzles, and wherein by controlling the opening or closing of the each first nozzle, the mixed material of the molding material and the supercritical fluid enters the mold cavity or stops entering a mold cavity. A method also performs the functions of the device.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic diagram of the overall structure of a multi-nozzle device without runners;

FIG. 2 is a schematic diagram of the structure of a multi-nozzle component;

FIG. 3 is a sectional view of the assembly of the multi-nozzle component and the no-mold-runner;

FIG. 4 is a control flow chart of a multi-nozzle device without runners;

FIG. 5 is a schematic diagram of the structure of a multi-nozzle component in multi-color injection molding;

FIG. 6 is a control flow chart of a multi-color injection molding device;

FIG. 7 is a schematic diagram of the structure of a multi-nozzle device adjusting device;

FIG. 8 is an enlarged view of a portion of the multi-nozzle device adjusting device;

FIG. 9 is a schematic diagram of the nozzle installation structure;

FIG. 10 is a schematic diagram of runner connection;

FIG. 11 is a schematic diagram of the structure of a multi-material injection device;

FIG. 12 is a schematic diagram of the alignment structure of the multi-nozzle device and the template;

FIG. 13 is a schematic diagram of a nozzle structure;

FIG. 14 is a schematic structural diagram of another multi-material injection device; and

FIG. 15 is a control flow chart of the multi-nozzle device.

### DETAILED DESCRIPTION

In the injection molding production process, the application of micro-foaming technology to form a small bubble structure inside the plastic, injection molding products of the same thickness, and under the condition that the performance is not greatly affected, it can save about 30% of the raw materials. Therefore, micro-foam injection molding has good market prospects and economic benefits.

Micro-foaming molding can be divided into three stages: first, the supercritical fluid (CO2 or N2) is melted into the hot melt adhesive to form a single-phase solution, and it is maintained under a certain constant pressure. The single-phase solution is injected into the mold cavity with lower temperature and pressure to form a micro-foamed product. The decrease in temperature and pressure triggers molecular instability, thereby forming a large number of bubble nuclei in the product, and these bubble nuclei generate tiny pores.

In the micro-foam injection molding process, when the pressure drops, the gas core formed by the supercritical fluid begins to foam and grow. Due to the single nozzle of the traditional injection molding machine and the hot runner inside the mold, when the nozzle is opened, the gas core mixed in the raw material begins to grow up, leading to foaming transition, and finally the foam formed inside the product is too large and destroys the inside structure.

When performing multi-color injection molding, the existing injection molding process methods are mainly parallel injection molding and vertical injection molding.

Parallel injection is to rotate the mold 180 degrees after the first color injection is completed, and another injection device completes the second color injection. Vertical injection is to distribute two injection screws vertically and inject from two gates respectively. Regardless of the parallel type or the vertical type, there are problems of complex structure and high space cost, and the design requirements of the mold are high, and the corresponding cost is also increased.

The flow channel inside the mold is single and too long, resulting in the growth of foaming raw materials in the injection process, and finally the products with large bubbles are formed.

The multi-color injection molding method has the problems of complex structure and high space cost, and has high requirements for mold design, and the corresponding cost also increases.

The technical solution of the invention is providing a no-mold-runner multi-nozzle device, including: an injection machine, a multi-nozzle component, a front template, and a no-mold-runner.

The multi-nozzle component is connected to the injection machine, and the injection machine injects and fills the material mixed with the molding material and the supercritical fluid into the mold through a plurality of nozzles.

The template is provided with a plurality of first passage holes. The no-mold-runner is provided with a mold cavity and a plurality of second passage holes communicating with the mold cavity, and the number of the second passage holes is not greater than the number of the first passage holes. A plurality of nozzles passes through the corresponding plurality of first passage holes and be installed in cooperation with the second passage holes. By controlling the opening or closing of the nozzle, the mixed material of the molding material and the supercritical fluid enters or blocks in the mold cavity.

The injection machine includes a screw, a barrel, an injection device, and an air injection device. There is a molding material in a molten state inside the barrel. The gas injection device injects supercritical fluid into the barrel. The molding material and the supercritical fluid are mixed to form a mixed material by using the screw in the barrel.

The injection device injects the mixed material into the plurality of nozzles.

The multi-nozzle component includes a main flow plate and a flow dividing rod. The flow dividing port provided on the main flow plate is correspondingly connected to one end of the flow dividing rod. the other end of the flow dividing rod is correspondingly connected to the nozzle.

Both the barrel and the shunt rod are equipped with solenoid valves, which are used to control the opening or closing of the barrel and the shunt rod.

The color of the molding material stored in each of the multiple barrels is different, and the barrel is controlled by a solenoid valve so that the molding materials of different colors are separately injected into the no-runner mold.

The injection machine also includes a position sensor mounted on the screw for detecting the position of the screw axial movement.

A pressure sensor is arranged in the mold cavity, and the pressure sensor is used to detect the pressure value inside the mold cavity.

The first passage holes are evenly arranged, and the number is greater than the number of the nozzles, and the diameter of the first passage holes is greater than the outer diameter of the nozzle.

The material of the no-mold-runner is aluminum alloy.

The programmable logic controller (PLC) central control system controls the opening and closing of the nozzle so that the mixed material of the molding material and the supercritical fluid enters the mold cavity or stops entering the mold cavity.

The present invention also provides a control method of a multi-nozzle device without a runner, which includes:

S1: The no-runner mold is provided with a mold cavity and a second passage hole communicating with the mold cavity. A pressure sensor is installed in the cavity. Multiple nozzles installed with two passage holes, and the opening time is set.

S2: The rotation of the screw inside the injection machine makes the molding material and the supercritical fluid fully mixed. When the mixture is mixed, the position sensor arranged on the screw sends the signal to the PLC central control system, so that the PLC central control system controls open the selected nozzle, and the screw is fed axially under the drive of the injection motor at this time, and the mixed material of the molding material and the supercritical fluid enters the cavity provided in the no-mold-runner through the nozzle.

S3: When the material mixed with the molding material and the supercritical fluid fills the inside of the mold cavity, the pressure sensor transmits a signal to the PLC central control system, and the PLC central control system controls to close the opened nozzle.

S4: After completing a cycle of injection, the PLC central control system stores the above control parameters.

The multi-nozzle component also includes a moving device. The moving device includes a primary moving device and a secondary moving device. The primary moving device drives at least two nozzles to move horizontally, and the secondary moving device allows each nozzle to perform angular rotation through two stages of movement, the spatial position of the nozzle is adjusted to fit different injection molds.

The alignment device includes a position signal transmitter and a position signal receiver. The position signal transmitter is fixedly installed on the injection mold, the signal receiver is fixedly installed on the main channel of the nozzle, and the position signal receiver receives the signal from the signal generator to determine the nozzle. Whether the center axis of the injection mold and the center axis of the injection mold are on the same axis, if there is a deviation, the moving device is controlled to automatically adjust the position of the nozzle to correct the deviation.

The primary moving device includes a sliding groove, an upper sliding plate, and a lower sliding plate. The sliding groove is arranged inside the main runner. The interface of the main runner is on the upper sliding plate. The upper and lower sliding plates can slide in the main runner and maintain good sealing.

The primary moving device also includes a turntable, a first link, a second link, a third link, a fourth link, and a connecting piece. The turntable is installed on the main flow channel, and one end of the first link is connected to the main flow channel. The middle part of the connecting rod is connected with the hinge end of the second connecting rod, the other end of the second connecting rod is connected with the hinge of the turntable, and the other end of the first connecting rod is connected with the hinge end of the third connecting rod. The other end of the third connecting rod is connected with the hinge end of the fourth connecting rod, and the fourth connecting rod is fixedly installed with the connecting piece. One end of the connecting piece is fixedly connected to the upper sliding plate.

The secondary moving device includes a motor, a positioning rod, a sliding rod, a connecting rod, and a ferrule. The motor is fixedly connected with the adjusting rod, the adjusting rod and the connecting rod are threadedly connected, the connecting rod and the ferrule are connected by a hinge, the connecting rod and the sliding rod are connected by a hinge, and the ferrule is fixedly connected with the vertical shunt. The vertical runner is a telescopic sleeve rod.

The nozzle also includes a feed tube, a stirring rod, a support plate, a slider switch, a heating coil, an insulation layer, and a temperature sensor. The tail of the nozzle is fixedly connected to the vertical flow channel, and the connection port of the feed tube is fixedly connected to the tail of the nozzle. A horizontal flow channel is arranged inside the nozzle, a stirring rod is arranged inside the horizontal flow channel, a support plate is fixed on the inner wall of the horizontal flow channel, and the support plate can be moved left and right to set a slider switch, and a heating ring is fixed on the outside of the horizontal flow channel. An insulation layer is arranged outside the heating coil, and a temperature sensor is fixed on the inner surface of the insulation layer. One side of the nozzle overlaps with one side of the injection mold. The nozzle can be used to mix two different injection materials.

When the nozzles are injecting, each nozzle can individually inject a fluid-like injection material, there are different colors of fluid-like injection material, and the injection parameters can also be individually controlled. The injection parameters include speed and pressure.

At the same time, the present invention also proposes another control method for a multi-nozzle device without a runner, which includes:

S1: The injection mold is equipped with a position signal transmitter, and the nozzle is equipped with a position signal receiver to receive the signal from the position signal transmitter to determine whether it is on the same axis. the injection device is equipped with a moving device to adjust the nozzle position. The moving device includes a primary moving device and secondary moving device.

S2: The primary moving device is driven by a small motor to adjust the position of each nozzle in the horizontal direction. When the nozzle and the injection hole of the mold are aligned in the horizontal direction, the primary moving device stops moving.

S3: The secondary moving device adjusts the angle and length of each nozzle through a small motor. When the nozzle hole and the injection hole of the mold are aligned on the same axis, the secondary moving device stops moving.

S4: The injection machine injects the molding material into the nozzle through the injection machine and the barrel, the two molding materials are uniformly mixed inside the nozzle, the nozzle is opened, and the molding material enters the mold through the nozzle.

S5: When the molding material fills the mold, close the opened nozzle. wait for the mold to complete a cycle of injection molding.

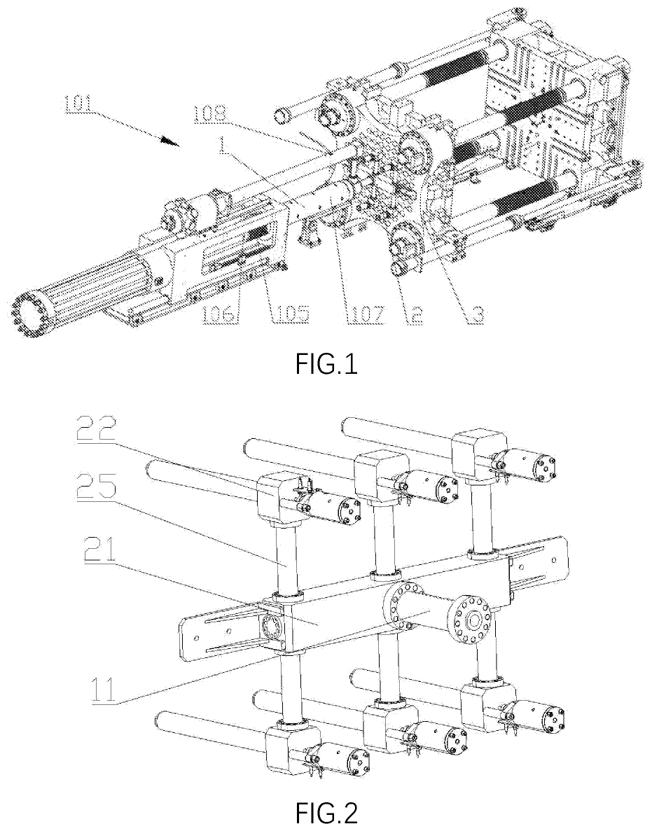

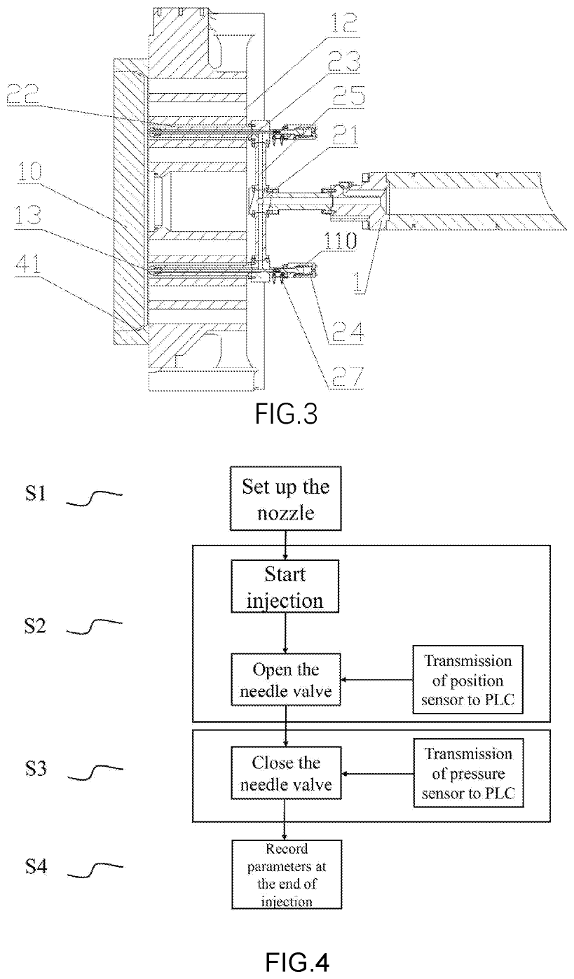

As shown in FIG. 1, FIG. 2 and FIG. 3, the present invention discloses a no-mold-runner multi-nozzle device 101, comprising: an injection machine 1, a multi-nozzle component 2, a front template 3 and a mold 4 such as a no-mold-runner 4.

The multi-nozzle component 2 includes a plurality of nozzles 22, and the multi-nozzle component 2 is connected to an injection machine 1, and the injection machine 1 is used for injecting a mixture of a molding material and a supercritical fluid into the plurality of nozzles 22.

As shown in FIG. 2, the multi-nozzle component 2 further includes a main flow plate 21 and a branch rod 25. The main flow plate 21 is provided with a branch port, and the branch port is connected to one end of the branch rod 25 in a one-to-one correspondence. The other end of the splitter rod 25 is connected to the nozzle 22 in a one-to-one correspondence.

The injection machine 1 includes a screw 105, a barrel 11, an injection device 107 and a gas injection device 108. Inside the barrel 11 there is a molten molding material, the gas injection device 108 injects the supercritical fluid into the barrel 11, and the screw 105 mixes the molding material and the supercritical fluid evenly inside the barrel 11 to form a mixed material. The injection device 107 injects the mixed material into the plurality of nozzles 22. The injection machine 1 also includes a position sensor 106 which is installed on the screw 105 and is used to detect the position of the axial movement of the screw 105.

The front template 3 is provided with a plurality of first passage holes 12. The no-mold-runner 4 is provided with a mold cavity and a plurality of second passage holes 13 communicating with the mold cavity. The plurality of nozzles 22 pass through the plurality of first passage holes 12 and are installed in cooperation with the plurality of second passage holes 13. By controlling the opening or closing of the nozzle 22, the mixed material of the molding material and the supercritical fluid enters the mold cavity through the nozzle 22 or stops entering the mold cavity. Specifically, the PLC central control system 109 controls the opening and closing of the nozzle 22 so that the mixed material of the molding material and the supercritical fluid enters or stops entering the mold cavity through the nozzle 22. A pressure sensor 41 may be provided in the mold cavity, and the pressure sensor 41 is used to detect the pressure value inside the mold cavity. The IO port of the pressure sensor 41 is connected with the PLC central control system. The PLC central control system controls the opening and closing of the nozzle 22 according to the pressure signal collected by the pressure sensor 41, so that the mixed material of the molding material and the supercritical fluid enters the cavity through the nozzle 22 or stops entering the cavity. In a specific embodiment, the material of the no-mold-runner 4 is aluminum alloy.

As shown in FIGS. 2 and 3, the nozzle 22 includes a nozzle flow path 110, a needle valve needle 23, a needle valve cylinder 24 and a proximity switch 27. The needle valve needle 23 is installed inside the nozzle flow path 110, and the nozzle flow path 110 is connected and disconnected from the mold cavity by the needle valve needle 23 through the second passage hole. The needle valve cylinder 24 is installed at the tail of the needle valve needle 23. The needle valve cylinder 24 controls the axial movement of the needle valve needle 23. The proximity switch 27 is used to sense the forward end position and the backward end position of the needle valve needle 23.

In order to adapt to nozzles 22 of different outer diameter sizes, the first passage holes 12 are arranged neatly and the number is greater than the number of nozzles 22, and the diameter of the first passage holes 12 is greater than the nozzle outer diameter. It can realize large-caliber injection channel with high adaptability, for different no-runner molds 4, according to the first passage hole arrangement of the front template, design the corresponding second passage hole position on the no-mold-runner, and apply multi-nozzle devices with different permutations and combinations. In this way, the injection can achieve the effect of multi-runner injection, thereby improving production efficiency.

The present invention also provides a control method of a multi-nozzle device without a runner, which includes the steps in FIG. 4:

S1: The no-mold-runner 4 is provided with a mold cavity and a second passage hole communicating with the mold cavity. a pressure sensor 41 is installed in the mold cavity. according to the position of the second passage hole provided by the no-mold-runner, a plurality of nozzles 22 is installed in cooperation with the second passage hole, and the opening time is set.

S2: start injection, the screw 105 inside the injection machine 1 rotates to feed the material mixed with the molding material and the supercritical fluid, when the injection screw is fed to a certain position, the position sensor arranged on the screw sends a signal to the PLC control system 109, the PLC central control system 109 controls the opening of the selected nozzle, and the material mixed with the molding material and the supercritical fluid enters the cavity provided inside the no-mold-runner through the nozzle.

S3: When the material mixed with the molding material and the supercritical fluid fills the interior of the mold cavity, the pressure sensor 41 transmits a signal to the PLC central control system 109, and the PLC central control system 109 controls to close the opened nozzle.

S4: After completing a cycle of injection, the PLC central control system 109 stores the above control parameters.

In a specific embodiment, in the injection preparation stage, the number of nozzles 22 of the multi-nozzle device 2 is 6 according to the situation of the no-mold-runner 10. When the injection is started, there is a molten molding material in the barrel 11 of the injection machine 1, and the gas injection device 108 injects supercritical fluid into the barrel 11. The screw mixes the molding material and the supercritical fluid uniformly inside the barrel 11 to form a mixed material. The injection device 107 injects the mixed material into the main flow plate 21, and the mixed material flows into the inside of each nozzle 22 through the splitter rod 25 inside the main flow plate 21. When the screw rotates to a certain position, the position sensor on the screw transmits the signal to the PLC central control system 109. The PLC central control system 109 gives instructions to the needle valve power system inside the nozzle 22 to drive the needle valve cylinder 24,

The needle valve cylinder 24 drives the needle valve needle 23 back. When the needle valve needle 23 retreats to a certain position, the proximity switch 27 senses the needle valve needle 23, and the retreat action of the needle valve needle 23 is terminated. At this time, the inside of the nozzle runner is connected, and the mixed material is injected into the cavity of the no-mold-runner 10. When the cavity is filled, the pressure sensor 41 inside the no-mold-runner 10 detects a certain pressure and transmits the signal to the PLC central control system 109. The PLC central control system 109 gives instructions to the needle valve power system inside the nozzle 22. Drive the needle valve cylinder 24, the needle valve cylinder 24 drives the needle valve needle 23 forward. When the needle valve needle 23 advances to a certain position, the proximity switch 27 senses the needle valve needle 23, and the forward movement of the needle valve needle 23 is terminated. At this time, the inside of the nozzle runner is closed, and after the inside of the no-mold-runner 10 is kept under pressure and cooled, a cycle of injection molding is completed. The invention discloses a no-mold-runner multi-nozzle device that can also perform multi-color injection molding. In a specific embodiment, as shown in FIG. 11, a plurality of barrels 11 are provided on the main flow plate 21, a solenoid valve 26 is also installed on the barrel 11, and a solenoid valve 26 is also installed on the shunt rod 25. The PLC central control system 109 controls the opening and closing of the solenoid valve 26. Each barrel 11 stores molding materials of different colors. The solenoid valve 26 controls the flow and closing of the barrel 11 and the shunt rod 25 and separates the molding materials of different colors into the no-mold-runner 10.

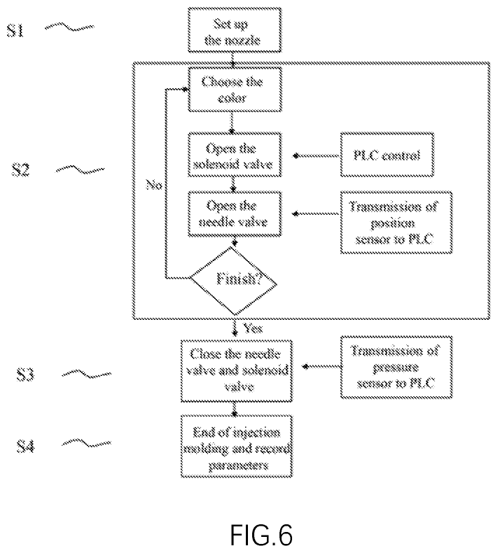

The present invention also discloses a method for controlling multi-color injection molding by a no-mold-runner multi-nozzle device, as shown in FIG. 6.

S1: The no-mold-runner is provided with a mold cavity and a second passage hole communicating with the mold cavity. a pressure sensor 41 is installed in the mold cavity. according to the position of the second passage hole provided in the no-mold-runner, Multiple nozzles are installed in the hole, and the opening time is set, the barrel is equipped with a solenoid valve, and the shunt rod is provided with a solenoid valve.

S2: Multiple barrels and the single-color molding material inside each barrel is stored, select the color order of injection, the PLC central control system 109 individually opens the solenoid valves on the multiple barrels, according to the selection of the injection point, Separately open the solenoid valve on the shunt rod, the screw inside the injection machine 1 rotates to fully mix the molding material with the supercritical fluid, when the mixture is mixed, the position sensor set on the screw sends the signal to the PLC central control system 109, The PLC central control system 109 controls the opening of the selected nozzle. At this time, the screw in the barrel is driven by the injection motor to feed axially, and the mixed material of the molding material and the supercritical fluid enters the cavity of the no-mold-runner through the nozzle.

S3: When the material mixed with the molding material and the supercritical fluid fills the cavity, the pressure sensor 41 transmits the signal to the PLC central control system 109, and the PLC central control system 109 controls to close the opened nozzles and all solenoid valves.

S4: After completing a cycle of injection, the PLC central control system 109 stores the above control parameters.

In a specific embodiment, in the injection preparation stage, the number of nozzles 22 of the multi-nozzle device 2 is 6 according to the situation of the no-mold-runner 10, and three barrels 11 are connected to the main flow plate 21. The three barrels 11 respectively store different colors of molding materials, start injection, and when the first color material is injected, the PLC central control system 109 controls to open the solenoid valve 26 on the left barrel 11 and the solenoid valves on the upper three shunt rods 26. The injection device 107 injects the first color material into the main flow plate 21, and the first color material is divided into the upper three nozzles 22 through the splitter rod 25 inside the main flow plate 21. The PLC central control system 109 gives instructions to the needle valve power system inside the nozzle 22 to drive the needle valve cylinder 24. The needle valve cylinder 24 drives the needle valve needle 23 to retreat. When the needle valve needle 23 retreats to a certain position, the switch 27 senses the needle valve needle 23, the back movement of the needle valve needle 23 is terminated. The nozzle runner is connected internally, and the mixed material is injected into the cavity of the no-mold-runner 10. When the timing of the nozzle 22 arrives, the PLC central control system 109 gives instructions to the needle valve power system inside the nozzle 22 to drive the needle valve cylinder 24, and the needle valve cylinder 24 drives the needle valve needle 23 to move forward. When the needle valve needle 23 advances to a certain position, the switch 27 senses the needle valve needle 23, and the forward movement of the needle valve needle 23 is terminated. At this time, the inside of the nozzle flow path is closed, and the PLC central control system 109 controls the solenoid valve 26 on the left barrel 11 and the solenoid valves 26 on the upper three shunt rods to close, stopping the injection of the first color material. When injecting the second color material, the PLC central control system 109 controls to open the solenoid valve 26 on the middle barrel 11 and the solenoid valve 26 on the lower three shunt rods. The injection device 107 injects the second color material into the main plate 21. The second color material is diverted into the next three nozzles 22 through the diverter rod 25 inside the main flow plate 21. The PLC central control system 109 gives instructions to the needle valve power system inside the nozzle 22 to drive the needle valve cylinder 24, which drives the needle valve cylinder 24. The needle valve needle 23 retreats, When the needle valve needle 23 retreats to a certain position, the switch 27 senses the needle valve needle 23, and the retreat action of the needle valve needle 23 is terminated. The nozzle runner is connected internally, and the mixed material is injected into the cavity of the no-mold-runner 10. When the timing of the nozzle 22 arrives, the PLC central control system 109 gives instructions to the needle valve power system inside the nozzle 22 to drive the needle valve cylinder 24, and the needle valve cylinder 24 drives the needle valve needle 23 to move forward. When the needle valve needle 23 advances to a certain position, the proximity switch 27 senses the needle valve needle 23, and the forward movement of the needle valve needle 23 is terminated. At this time, the inside of the nozzle flow path is closed, and the PLC central control system 109 controls the solenoid valve 26 on the intermediate barrel 11 and the solenoid valve 26 on the lower three shunt rods to close and stop the injection of the second color material. When injecting the third color material, the PLC central control system 109 controls to open the solenoid valve 26 on the right-side barrel 11 and the solenoid valves 26 on the six shunt rods. The injection device 107 injects the third color material into the main plate 21. The three-color material is diverted into the six nozzles 22 through the diverter rod 25 inside the main plate 21,

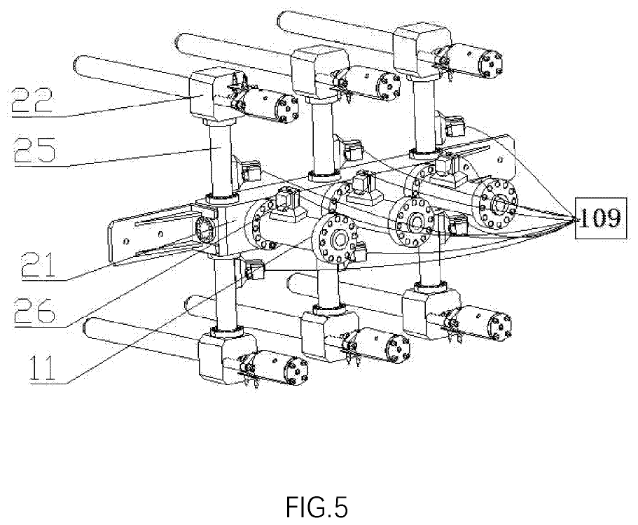

Regarding FIG. 5, the PLC central control system 109 gives instructions to the needle valve power system inside the nozzle 22 to drive the needle valve cylinder 24, and the needle valve cylinder 24 drives the needle valve needle 23 to retreat. When the needle valve needle 23 retreats to a certain position, the switch 27 senses the needle valve needle 23, and the retreat action of the needle valve needle 23 is terminated. At this time, the nozzle flow channel is connected internally, and the mixed material is injected into the cavity of the no-mold-runner 10 internal. When the timing of the nozzle 22 arrives, the PLC central control system 109 gives instructions to the needle valve power system inside the nozzle 22 to drive the needle valve cylinder 24, and the needle valve cylinder 24 drives the needle valve needle 23 to move forward. When the needle valve needle 23 advances to a certain position, the switch 27 senses the needle valve needle 23, the forward movement of the needle valve needle 23 is terminated, and the nozzle flow channel is closed. The PLC central control system 109 controls the solenoid valve 26 on the right barrel 11 and the solenoid valves 26 on the six shunt rods to close, stop the injection of the third color material, and complete a cycle of injection after the internal pressure of the no-mold-runner 10 is kept and cooled.

The present invention eliminates the hot runner on the conventional injection mold and replaces the hot runner with the second through hole, which simplifies the design of the conventional no-mold-runner and saves costs. Due to the small hole diameter of the hot runner and the lengthy runner, higher pressure is required for injection when the molding material is injected into the cavity. After replacing the hot runner with a long nozzle, not only the efficiency of injection molding is improved, but the pressure during injection is reduced, which reduces cost of the equipment is reduced, and the production cycle is shortened at the same time. When multi-color injection molding is performed, the multi-color barrel is connected on the mainstream board, and the solenoid valve is used to control the switch, which not only saves the space cost of the multi-color injection device 107, but also improves the injection efficiency. The sequence of multi-color injection can be flexible and changeable.

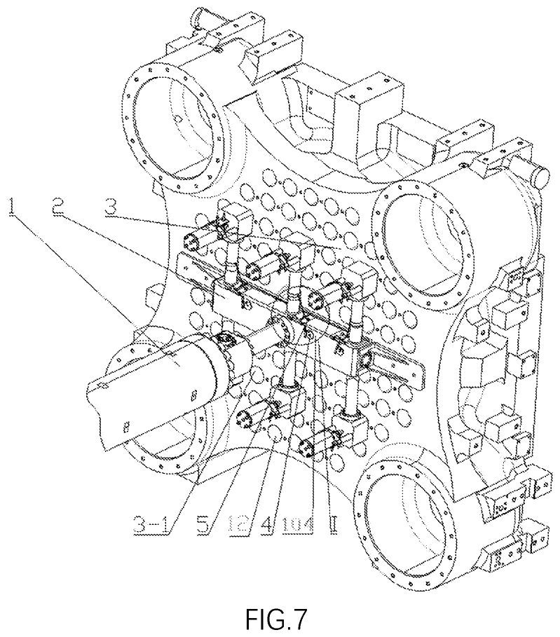

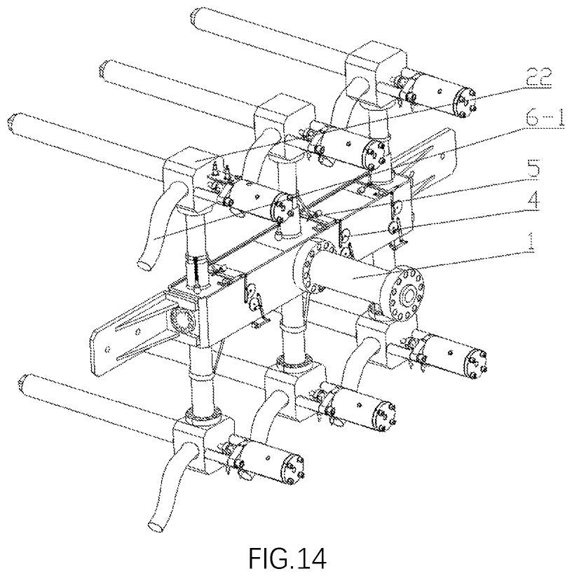

As shown in FIGS. 7-15, the present invention discloses another injection device 107, which is connected to an injection machine 1 for injecting the molding material of the injection machine 1 into an injection mold 10. A moving device 104 for adjusting the position of the injection nozzle 22. The moving device 104 includes a primary moving device 4 and a secondary moving device 5. The primary moving device 4 drives at least two nozzles 22 to move horizontally. The moving device 105 allows each nozzle 22 to perform angular rotation, and through two-stage movement, the spatial position of the nozzle 22 is adjusted to fit different injection molds.

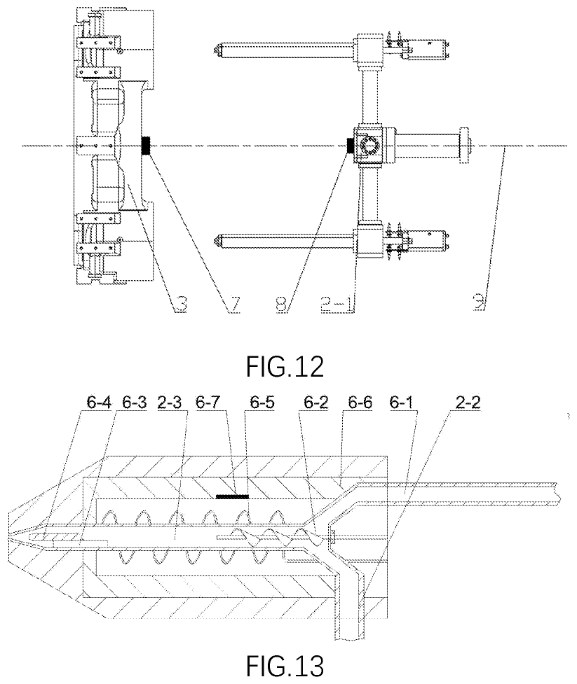

In one embodiment, as shown in FIG. 12, the injection device 107 includes an alignment device, the alignment device includes a position signal transmitter 7 and a position signal receiver 8. The position signal transmitter 7 is fixedly installed on the injection mold 10.

The position signal receiver 8 is fixedly installed on the main runner 2-1 of the nozzle 22. The position signal receiver 8 receives the signal from the position signal transmitter 7 to determine whether the center axis of the nozzle 22 and the center axis of the injection mold 10 are on the same line. If there is a deviation on the axis, the moving device is controlled to automatically adjust the position of the injection nozzle to correct the deviation.

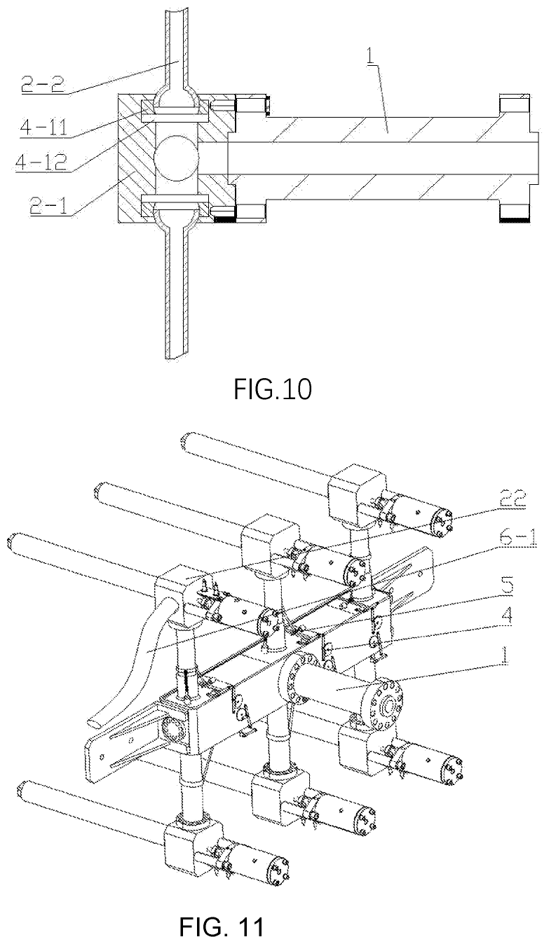

In one embodiment, as shown in FIG. 9 and FIG. 10, the nozzle 22 includes a main flow channel 2-1, a vertical flow channel 2-2, a horizontal flow channel 2-3, a valve core 2-4 and a needle valve cylinder 2-5. The main runner 2-1 is provided with an interface for docking with the vertical runner 2-2 and the connection method is spherical connection. The horizontal runner 2-3 is arranged inside the nozzle 22 and is connected to the vertical runner 2-2. The spool 2-4 controls the flow, and the spool 2-4 is controlled by the needle valve cylinder 2-5.

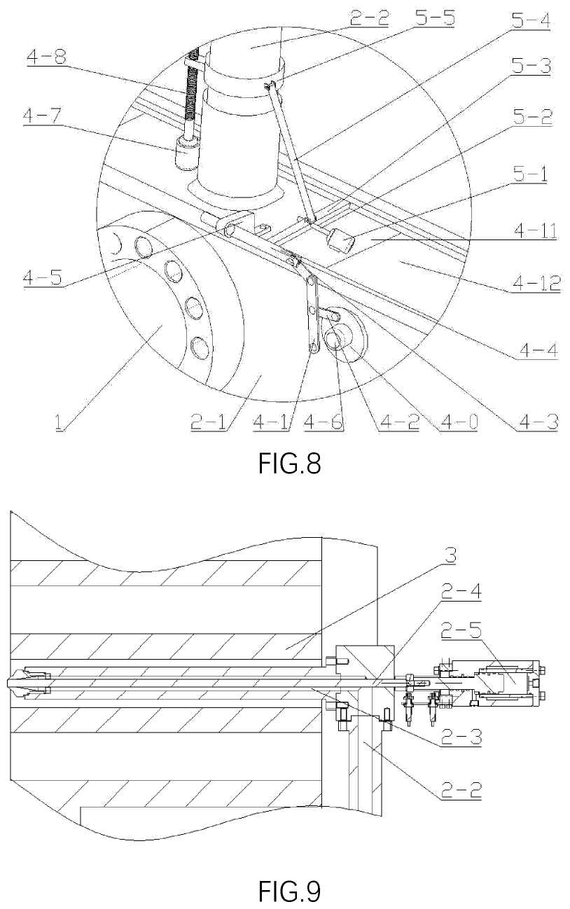

In one embodiment, as shown in FIG. 8, the primary moving device 4 includes a sliding groove, an upper sliding plate 4-11, and a lower sliding plate 4-12. The sliding groove is set inside the main runner 2-1, and the interface opened on the main runner 2-1 is on the upper slide 4-11. The upper sliding plate 4-11 and the lower sliding plate 4-12 can translate and slide inside the main runner 2-1 and maintain good sealing.

The primary moving device 4 also includes a turntable 4-9, a first connecting rod 4-1, a second connecting rod 4-2, a third connecting rod 4-3, a fourth connecting rod 4-4, and a connecting piece 4-5. The turntable 4-9 is rotatably installed on the main runner 2-1. One end of the first link 4-1 is rotatably connected to the main channel 2-1. The middle part of the first link 4-1 is connected with the hinge end of the second link 4-2. The other end of the second link 4-2 is connected to the turntable 4-9. The other end of the first link 4-1 is connected to the hinge end of the third link 4-3. The other end of the third link 4-3 is connected to the hinge end of the fourth link 4-4. The connecting piece 4-5 is also fixedly installed on the fourth connecting rod. One end of the connecting piece 4-5 is fixedly connected to the upper sliding plate 4-11.

The secondary moving device 5 includes a motor 5-1, an adjusting rod 5-2, a sliding rod 5-3, a connecting rod 5-4, and a ferrule 5-5. The motor 5-1 is fixedly connected with the adjusting rod 5-2. The adjusting rod 5-2 and the connecting rod 5-3 are threadedly connected. The connecting rod 5-3 and the ferrule 5-5 are connected by a hinge. The connecting rod 5-4 and the sliding rod 5-3 are connected by a hinge. The ferrule 5-5 is fixedly connected with the vertical branch runner 2-2. The vertical runner 2-2 is a telescopic sleeve rod, which can be adjusted in length.

In a specific embodiment, after replacing the injection mold 10, the position signal transmitter 7 sends a signal. The signal is received by the position signal receiver 8, and it is determined that the center axis of the nozzle 22 and the center axis of the injection mold 10 are not on the same axis 9, and there is a certain position error. Start the motor 4-6, the motor 4-6 drives the turntable 4-9 to rotate, and the turntable 4-9 drives the second connecting rod 4-2 to move. The second connecting rod 4-2 drives the first connecting rod 4-1 to rotate to the right. The first link 4-1 drives the third link 4-3 to move to the right. The third link 4-3 drives the fourth link 4-4 to move to the right, Since the connecting piece 4-5 is fixedly connected with the upper sliding plate 4-11 and the fourth connecting rod 4-4, The upper slide 4-11 can only move in the sliding groove in the main runner 2. The fourth link 4-4 can only move to the right, so the movement of the fourth link 4-4 can drive the upper slide 4-11 to move to the right.

A vertical runner 2-2 is fixed on the upper slide 4-11. A nozzle 22 is fixed on the vertical runner 2-2. The nozzle 22 can follow the upper slide 4-11 to pan to the right, after the nozzle 22 reaches the horizontal position of the mounting hole, the vertical runner 2-2 expands and adjusts the vertical position. The nozzle 22 and the mounting hole are on the same axis, and the first-stage movement ends. The second movement starts, start the motor 5-1, the motor 5-1 drives the adjustment rod 5-2 to rotate, the adjustment rod 5-2 drives the sliding rod 5-3 to move to the right, because the adjustment rod 5-2 and the connecting rod 5-4 hinge connection. The connecting rod 5-4 is driven to move to the right by the sliding rod 5-3, and at the same time, the angle between the connecting rod 5-4 and the upper sliding plate 4-11 becomes smaller. Because the connecting rod 5-4 is connected with the ferrule 5-5, the ferrule 5-5 is fixedly installed on the vertical runner 2-2, and the vertical runner 2-2 is connected to the upper sliding plate 4-11 spherically. The runner 2-2 moves with the connecting rod 5-4, the angle between the vertical runner 2-2 and the upper sliding plate 4-11 is reduced, and the rotation of the motor 5-1 is stopped. At this time, the sliding rod 5-3 and the connecting rod 5-4 stop moving. The vertical runner 2-2 is fixed at a certain angle of inclination. The motor 4-7 is started, and the screw 4-8 rotates to drive and extend the length of the vertical runner 2-2 until the nozzle 22 and the mounting hole on the injection mold 10 remain on the same axis.

The present invention also discloses a combined injection nozzle. In one embodiment, as shown in FIG. 11 and FIG. 13, the nozzle 22 also includes a feed tube 6-1, a stirring rod 6-2, a support plate 6-3, and a slider switch. 6-4, heating coil 6-5, insulation layer 6-6, temperature sensor 6-7. The tail of the nozzle 22 is fixedly connected to the vertical branch 2-2. The connection port of the material pipe 6-1 is fixedly connected to the tail of the nozzle 22. A horizontal flow channel 2-3 is arranged inside the nozzle 22. The stirring rod 6-2 is rotatably arranged inside the horizontal flow channel 2-3. A support plate 6-3 is fixedly arranged on the inner wall of the horizontal flow channel 2-3. The support plate 6-3 is provided with a slider switch 6-4 movably left and right. A heating ring 6-5 is fixedly arranged on the outside of the horizontal runner 2-3. The heating coil 6-5 is provided with an insulation layer 6-6 outside. The temperature sensor 6-7 is fixedly arranged on the inner surface of the thermal insulation layer 6-6. The leftmost surface of the nozzle 22 coincides with the left end surface of the injection mold 10, and the nozzle 22 can be used to mix two different injection materials.

In a specific embodiment, as shown in FIG. 11, the nozzles 22 are combined, and the first injection nozzle on the left uses a hybrid injection nozzle. The slide switch 6-4 inside the nozzle 22 blocks the left end exit of the horizontal flow channel 2-3 and is in a closed state. When working, the molding material is injected into the nozzle 22 from the vertical runner 2-2, and the supercritical fluid is injected into the nozzle 22 from the material pipe 6-1 at the same time. When the molding material and the supercritical fluid are injected into the nozzle 22 together, the control system controls the motor to drive the stirring rod 6-2 to rotate at a high speed to stir the molding material and the supercritical fluid evenly. While the stirring rod 6-2 is working, the control system controls the heating coil 6-5 to heat the mixed raw materials in the horizontal flow channel 2-3 inside the nozzle 22 to keep the mixed raw materials in a molten state. The temperature sensor 6-7 detects the internal temperature of the nozzle 22 and transmits the temperature to the host computer in real time. The control system controls the slider switch 6-4 to shift to the right, opening the horizontal flow channel 2-3. Fill the cavity of the injection mold 10 with mixed raw materials, and the control system controls the slider switch 6-4 to move to the left to block the horizontal flow channel 2-3. That is, the nozzle 22 is turned off and cooled and molded to form plastic products with different parts, different materials, and different colors.

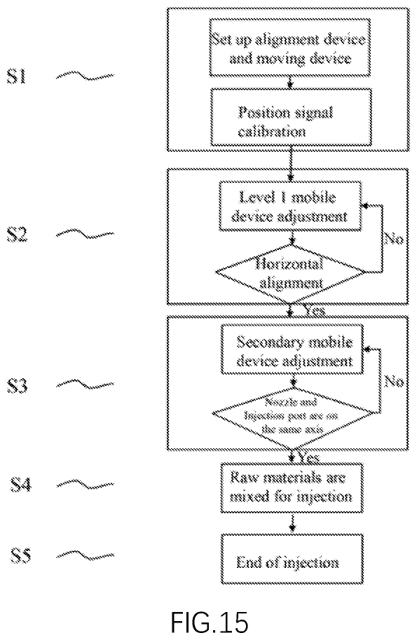

FIG. 15 is a schematic flow chart of the present invention regarding the injection molding machine control method. As shown in the figure, the method includes the steps:

S1: A position signal transmitter 7 is set on the mold 4, and a position signal receiver 8 is set on the injection nozzle to receive the signal from the position signal transmitter 7 and determine whether they are on the same axis. A moving device is arranged on the injection device 107 to adjust the position of the nozzle 22, and the moving device includes a primary moving device 4 and a secondary moving device 5.

S2: The primary moving device 4 is driven by a small motor 5-1 to adjust the position of each injection nozzle 22 in the horizontal direction. When the injection nozzle 22 and the injection hole of the mold are aligned in the horizontal direction, the primary stage moving device stops moving.

S3: The secondary moving device 5 is driven by a small motor to adjust the angle and length of each injection nozzle 22. When the hole of the injection nozzle 22 and the injection hole of the mold are aligned on the same axis, the secondary moving device stops moving.

S4: The injection machine 1 injects the molding material into the injection nozzle 22 through the injection barrel and the barrel, and the two molding materials are uniformly mixed inside the injection nozzle 22. Open the injection nozzle 22, and the molding material enters the mold through the nozzle 22.

S5: When the molding material fills the inside of the mold, close the opened nozzle 22. wait for the mold to cool and form to complete a cycle of injection molding.

It will be apparent to those skilled in the art that modifications and variations can be made without departing from the scope and spirit disclosed by the appended claims of the present disclosure, and such modifications and variations all fall in the protection extent of the claims of the present disclosure.

We claim:

1. A no-mold-runner multi-nozzle device comprising:
an injection machine;
a multi-nozzle component connected to the injection machine;
a front template comprising a plurality of first passage holes;
a no-mold-runner comprising a mold cavity and a plurality of second passage holes communicating with the mold cavity, and the number of the second passage holes is not greater than the number of the first passage holes; and
a plurality of nozzles that pass through the corresponding plurality of first passage holes and communicating with the second passage holes,
wherein the injection machine injects and fills material mixed with molding material and the supercritical fluid into the mold through a plurality of nozzles, and wherein by controlling the opening or closing of the each first nozzle, the mixed material of the molding material and the supercritical fluid enters the mold cavity or stops entering a mold cavity of the mold.

2. The no-mold-runner multi-nozzle device according to claim 1, wherein each nozzle comprises a nozzle runner, a needle valve needle, a needle valve cylinder, and a proximity switch;
the needle valve needle is installed inside the nozzle flow passage, and the nozzle flow passage is connected to and disconnected from the mold cavity by the needle valve needle after the nozzle flow passage is connected to the second passage hole;
the needle valve cylinder is installed at the tail of the needle valve needle, and the needle valve cylinder controls the axial movement of the needle valve needle; and
the proximity switch senses the forward end position and the backward end position of the needle valve needle.

3. The no-mold-runner multi-nozzle device according to claim 1, wherein the injection machine comprises a screw, a barrel, an injection device, and an air injection device, wherein a molten molding material is in the barrel, a gas injection device injects supercritical fluid into the barrel, the screw mixes the molding material and the supercritical fluid evenly inside the barrel to form a mixed material, and the injection device injects the mixed material into a plurality of nozzles.

4. The no-mold-runner multi-nozzle device according to claim 3, wherein the multi-nozzle component further comprises a main flow plate and a splitter rod, the main flow board is provided with a shunt port, the shunt port is connected to one end of the shunt rod in a one-to-one correspondence, the other end of the splitter rod is connected with the nozzle in a one-to-one correspondence.

5. The no-mold-runner multi-nozzle device according to claim 4, wherein a solenoid valve is installed on the barrel, a solenoid valve is installed on the shunt rod, and the solenoid valve controls the circulation and closing of the barrel and the shunt rod.

6. The no-mold-runner multi-nozzle device according to claim 5, wherein there are multiple barrels, the color of the molding material stored in each barrel is different, and the solenoid valve controls circulation and closes so that the molding materials of different colors are separately injected into the inside of the no-mold-runner.

7. The no-mold-runner multi-nozzle device according to claim 3, wherein the injection machine further comprises a position sensor installed on the screw and that detects the position of the axial movement of the screw.

8. The no-mold-runner multi-nozzle device according to claim 1, wherein a pressure sensor in the cavity detects a pressure value inside the mold cavity.

9. The no-mold-runner multi-nozzle device according to claim 1, wherein the first passage holes are evenly arranged, a number of passage holes is greater than a number of the nozzles, and a diameter of the first passage hole is larger than the outer diameter of the nozzle.

10. The no-mold-runner multi-nozzle device according to claim 1, wherein a material of the no-mold-runner is aluminum alloy.

11. The no-mold-runner multi-nozzle device according to claim 1, further comprising a programmable logic controller (PLC) central control system that controls the opening and closing of the nozzle so that the mixed material of the molding material and the supercritical fluid enters the mold cavity.

12. The multi-nozzle device according to claim 1, the multi-nozzle component comprising a moving device comprising a primary moving device and a secondary moving device, wherein the primary moving device drives the at least two nozzles to move horizontally, and the secondary moving device regularly rotates each nozzle perform, and the spatial position of the nozzle is adjusted to adapt to different injection mold through a first-stage movement and a second-stage movement.

13. The no-mold-runner multi-nozzle device according to claim 12, further comprising a position alignment device, the alignment device comprising a position signal transmitter and a position signal receiver, and the position signal transmitter is fixedly installed In the injection mold, the signal receiver is fixedly installed on the main runner of the nozzle, and the position signal receiver receives the signal from the signal generator to determine whether the center axis of the nozzle is in line with the center axis of the injection mold, wherein if there is a deviation on the same axis, the moving device is controlled to automatically adjust the position of the nozzle to correct the deviation.

14. The no-mold-runner multi-nozzle device according to claim 12, wherein the primary moving device comprises a sliding groove, an upper sliding plate, and a lower sliding plate, and the sliding groove is arranged inside the main flow channel, the interface of the main flow channel is on the upper sliding plate, and the upper and lower sliding boards can translate and slide inside the main flow channel and maintain good sealing performance.

15. The no-mold-runner multi-nozzle device according to claim 12, wherein the primary moving device further comprises a turntable, a first connecting rod, a second connecting rod, a third connecting rod, and a fourth connecting rod and connectors, the turntable is rotatably installed on the main runner, one end of the first link is rotatably connected to the main flow channel, a middle part of the first connecting rod is connected with a hinge of the second connecting rod, another end of the second link is connected with a hinge, the other end of the first link is connected with a hinge of the third link, another end of the third link is connected with a hinge of the fourth link, a connecting piece is fixedly installed on the fourth connecting rod, one end of the connecting piece is fixedly connected to the upper sliding plate.

16. The non-runner multi-nozzle device according to claim 12, wherein the primary moving device and the secondary moving device comprise a motor, a position adjustment rod, a sliding rod, a connecting rod, and a ferrule, the motor is fixedly connected with the adjusting rod, the adjusting rod and the connecting rod are threadedly connected, the connecting rod and the ferrule are connected by a hinge, the connecting rod and the sliding rod are connected by a hinge, the ferrule is fixedly connected with the vertical branch runner, and the vertical branching channel is a telescopic sleeve rod, which can be adjusted in length.

17. The multi-nozzle device without runner according to claim 12, wherein the nozzle further comprises a material tube, a stirring rod, a support plate, a slider switch, a heating coil, an insulation layer, and a temperature sensor, the tail of the nozzle is fixedly connected to the vertical flow channel, the connection port of the material pipe is fixedly connected to the tail of the nozzle, and a horizontal flow channel is arranged inside the nozzle, the stirring rod is rotatably arranged, and a support plate is fixedly arranged on the inner wall of the horizontal flow channel, the support plate is provided with a slider switch that can move left and right, a heating coil is fixed on the outside of the horizontal flow channel, a heat preservation layer is provided outside the heating coil, a temperature sensor is fixed on the inner surface of the heat preservation layer, one side of the nozzle coincides with one side of the injection mold, and the nozzle can be used to mix two different injection molding materials.

18. The no-mold-runner multi-nozzle device according to claim 12, wherein when the nozzles are injecting, each of the nozzles is individually controlled to inject fluid-like injection materials of different colors and wherein injection parameters comprising speed and pressure are adjusted.

19. A method for controlling an injection molding machine comprising:
equipping an injection mold with a position signal transmitter;
equipping a nozzle with a position signal receiver to receive the signal from the position signal transmitter and determine whether the injection mold is on the same axis;
equipping an injection device with a moving device to adjust the nozzle position, the moving device comprising primary moving devices and secondary moving devices;
adjusting the position of each nozzle in the horizontal direction with the primary moving device motivated by a small motor wherein when the nozzle and the injection hole of the mold are aligned in the horizontal direction, the primary moving device stops moving;
adjusting the angle of each nozzle with the secondary moving device motivated by the small motor, wherein when the nozzle hole and the injection hole of the mold are aligned on the same axis, the secondary moving device stops moving;
injecting the molding material into the nozzle through the injection machine and the barrel, wherein two molding materials are evenly mixed inside the nozzle, the nozzle is opened, and the mixed molding material enters the mold through the nozzle;
in response to the molding material filling an inside of the mold, closing the opened nozzle; and waiting until the mold is formed to complete one cycle of injection molding.

20. The method for controlling an injection molding machine according to claim 19, the method further comprising:
installing a needle valve inside the nozzle flow passage, wherein the nozzle flow passage is connected to and disconnected from the mold cavity by the needle valve needle after the nozzle flow passage is connected to the second passage hole;
installing a needle valve cylinder at the tail of the needle valve needle, wherein the needle valve cylinder controls the axial movement of the needle valve needle; and
sensing with a proximity switch the forward end position and the backward end position of the needle valve needle.
